(19) United States
(12) Patent Application Publication
(10) Pub. No.: US 2007/0296876 A1
(43) Pub. Date: Dec. 27, 2007

(54) Liquid crystal receiving apparatus

(75) Inventor: Munehiro Terada, Saitama (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/636,618

(22) Filed: Dec. 11, 2006

(30) Foreign Application Priority Data
Jun. 26, 2006 (JP) 2006-175889

(51) Int. Cl. H04N 3/14

(52) U.S. Cl. 348/790

(57) ABSTRACT

A liquid crystal receiving apparatus (1) according to the invention doubles the number of frames by doubling a vertical scanning frequency set for a received video signal (12), and adjusts a gain for each of frames added by the doubling (14). A moving image blur is prevented by reducing the gain, and a flicker is prevented by increasing the gain. The gain is adjusted automatically or through a manipulation made by a user in accordance with contents of an image to be displayed.

The present application is based on Japanese patent application No. 2006-175889, the entire contents of which are incorporated herein by reference.

### BACKGROUND

1. Field

One embodiment of the invention relates to a liquid crystal receiving apparatus, and more particularly to a liquid crystal receiving apparatus which is capable of suppressing “a moving image blur” as compared with that in a conventional liquid crystal receiving apparatus and of also coping with a flicker and a reduction in screen illuminance which are easy to occur as a result of taking measures to cope with the moving image blur.

2. Description of the Related Art

A CRT used in a conventional image display device has involved a problem that a flicker is easy to occur because a so-called impulse type display method has been adopted in which light emission occurs only for a part of a time period for each of frames of images.

In order to take measures to cope with such a flicker, the various technical developments have been carried out. The contents of these technical developments, for example, are disclosed in the Japanese Patent Kokai Nos. 11-8811 and 2005-191857.

On the other hand, a liquid crystal display device (LCD) which has been recently adopted in many image display apparatuses adopts a so-called hold type display method in which the light emission is made for the full time period for each of frames. For this reason, the LCD has the poor responsibility, as its shortcoming, that a displayed image slowly disappears, which results in that a state of “a moving image blur” occurs.

In order to dissolve such “a moving image blur” inherent in the LCD, a method has been devised such that a vertical scanning frequency (60 Hz in Japan, etc., and 50 Hz in Europe, etc.) is doubled, and a black frame is inserted between the existing frames in correspondence to the increased number of frames. This method, for example, is disclosed in the Japanese Patent Kokai No. 09-18814.

However, according to the conventional liquid crystal display device, since the insertion of the black frame between the existing frames results in that the display method concerned becomes close to the impulse type display method, the flicker becomes easy to occur. Also, since the time period required for the image display becomes half conventional one, the brightness of the picture decreases by one-half.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic view showing an exterior appearance of an image receiving system including a liquid crystal receiving apparatus according to the invention;

FIG. 2 is an exemplary block diagram showing an internal configuration of a liquid crystal receiving apparatus according to a first embodiment of the invention;

FIGS. 3A and 3B are respectively exemplary schematic diagrams showing operation for doubling the number of frames of a video signal received by the liquid crystal receiving apparatus according to the first embodiment of the invention;

FIGS. 3C and 3D are respectively exemplary schematic diagrams showing operation for controlling gains for ones of the frames the number of which are obtained by doubling the number of original frames;

FIGS. 4A to 4D are respectively exemplary schematic diagrams showing operation in which the liquid crystal receiving apparatus according to the first embodiment of the invention adjusts a gain for a video signal in accordance with a value of a gain set in advance;

FIG. 5 is an exemplary flow chart showing operation when the liquid crystal receiving apparatus according to the first embodiment of the invention receives a video signal and adjusts a gain for an image corresponding to the received video signal;

FIG. 6 is an exemplary block diagram showing an internal configuration of a liquid crystal receiving apparatus according to a second embodiment of the invention;

FIG. 7 is an exemplary schematic diagram showing a display example of a gain adjustment menu in an OSD image menu of the liquid crystal receiving apparatus according to the second embodiment of the invention; and

FIG. 8 is an exemplary flow chart showing operation the liquid crystal receiving apparatus according to the second embodiment of the invention in which a gain control of an image is carried out.

### DETAILED DESCRIPTION OF PREFERRED EMBODIMENTS

Various embodiments according to the invention will be described hereinafter with reference to the accompanying drawings. In general, according to one embodiment of the invention, there is provided a liquid crystal receiving apparatus, including: a receiving portion for receiving a video signal; an image frequency-doubling portion for adding frames the number of which increases by doubling a vertical scanning frequency for the video signal to existing frames of the video signal; a gain adjusting portion for adjusting a gain for each of the frames added in the image frequency-doubling portion; and an image displaying portion for displaying thereon an image corresponding to a video signal obtained from the existing frames and the added frames for which the gain adjustment is performed.

According to the liquid crystal receiving apparatus of the invention, the gain for each of the frames the number of which is doubled is adjusted in accordance with the contents of the image such as a still image or a moving image, which results in that the measures to cope with “the moving image blur”, the measures to cope with the flicker, and the like can be taken as occasion may demand, and thus the image can be optimally displayed.

In addition, according to a further embodiment of the invention, there is provided a liquid crystal receiving apparatus, comprising: a receiving portion for receiving a video signal; an image frequency-doubling portion for adding frames the number of which increases by doubling a vertical scanning frequency for the video signal to existing frames of the video signal; a timing generating circuit portion for generating a timing signal in accordance with the doubled vertical scanning frequency; a gain adjusting portion for adjusting a gain for the timing signal; an image adjusting circuit portion for adjusting the gain for each of the added frames by multiplying each of the added frames by the timing signal for which the gain is adjusted, and outputting the resulting added frames together with the existing frames in a form of a video signal; and an image displaying portion for displaying thereon an image corresponding to the video signal outputted from the image adjusting circuit portion.

According to the liquid crystal receiving apparatus of the invention, the gain for each of the frames the number of which is doubled is adjusted in accordance with the contents of the image such as a still image or a moving image, which results in that the measures to cope with “the moving image blur”, the measures to cope with the flicker, and the like can be also taken as occasion may demand, and thus the image can be optimally displayed.

In addition, according to a still further embodiment of the invention, there is provided a liquid crystal receiving apparatus, including: a receiving portion for receiving a video signal; an image frequency-doubling portion for adding frames the number of which increases by doubling a vertical scanning frequency for the video signal to existing frames of the video signal; an image quality-adjusting portion for performing display adjustment for an image quality; a gain adjusting portion for adjusting a gain for each of the frames added in the image frequency-doubling portion in accordance with the display adjustment for the image quality made in the image quality-adjusting portion; and an image displaying portion for displaying thereon an image corresponding to the video signal from which the existing frames, and the added frames for which the gain adjustment is performed are obtained.

According to the liquid crystal receiving apparatus of the invention, the gain for each of the frames the number of which is doubled is adjusted in accordance with the image quality adjustment, which results in that the image which a user is enjoying can be optimally displayed.

According to the invention, the gain for each of the frames the number of which is doubled is adjusted in accordance with the contents of the image such as a still image or a moving image, which results in that the measures to cope with “the moving image blur”, the measures to cope with the flicker, and the like can be taken as occasion may demand, and thus the image can be optimally displayed.

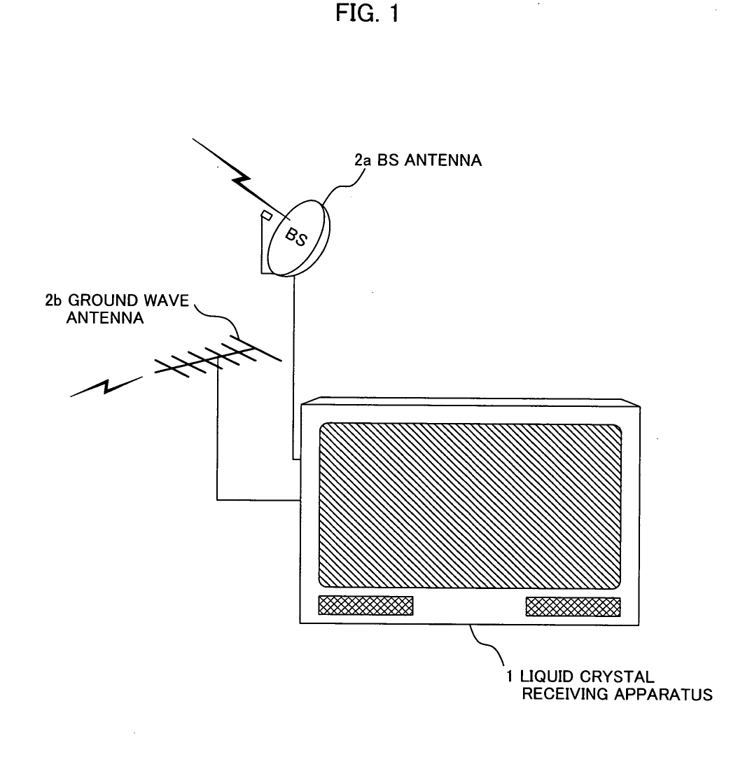

First and second embodiments of the invention will be described in detail hereinafter with reference to FIGS. 1 to 8.

### First Embodiment

### (Construction of System)

FIG. 1 is a schematic view showing an exterior appearance of an image receiving system including a liquid crystal receiving apparatus according to the invention.

An image receiving system includes a liquid crystal receiving apparatus 1 according to the invention, and a plurality kind of antennas for receiving electric waves for television broadcastings, respectively.

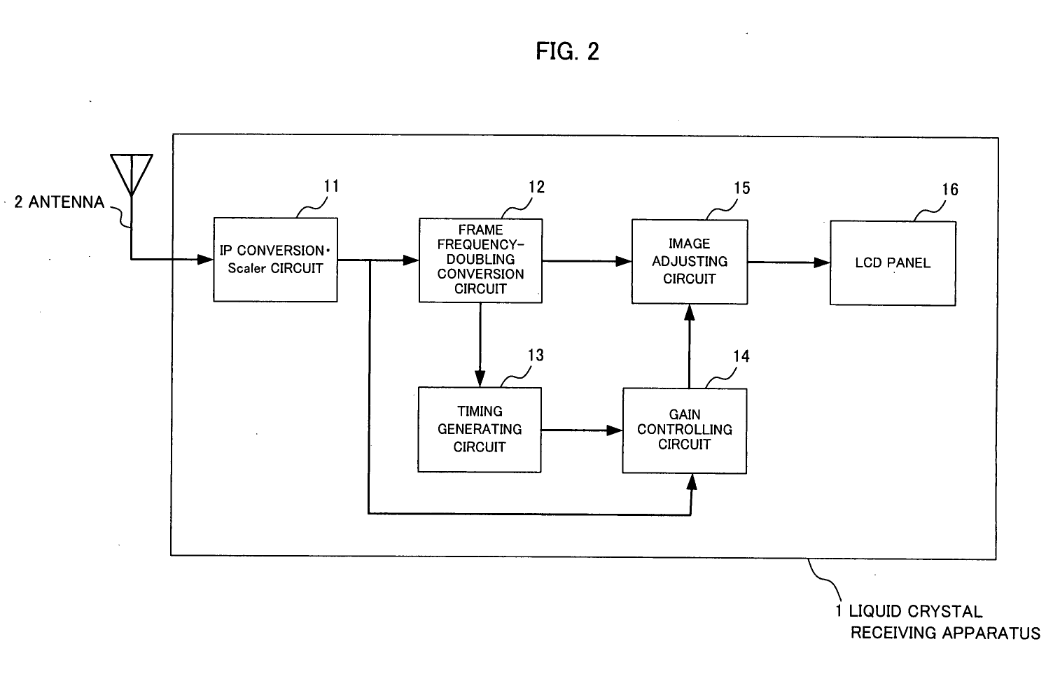

The liquid crystal receiving apparatus 1 receives a television broadcasting wave transmitted from a broadcasting station, and displays a television image corresponding to a video signal contained in the television broadcasting wave thus received. Also, an LCD panel 16 (refer to FIG. 2) for displaying thereon the television image is provided in the liquid crystal receiving apparatus 1.

In addition, a BS antenna 2a for receiving therethrough a wave for a satellite broadcasting, and a ground wave antenna 2b for receiving therethough a wave for a ground wave broadcasting are connected from the outside to the liquid crystal receiving apparatus 1. The liquid crystal receiving apparatus 1 receives the television broadcasting waves through the BS antenna 2a and the ground wave antenna 2b, respectively.

### (Configuration of Liquid Crystal Receiving Apparatus)

The liquid crystal receiving apparatus 1 according to the invention subjects frames of a video signal received thereat to frequency-doubling conversion processing, and reduces a gain for each of the resulting frames the number of which is doubled through the frequency-doubling conversion processing, thereby suppressing a flicker. Here, two kinds of methods now are proposed with respect to adjustment for a width in reduction of the gain. Then, the liquid crystal receiving apparatuses according to first and second embodiments of the invention will be described hereinafter with reference to the accompanying drawings, respectively.

The liquid crystal receiving apparatus 1 according to the first embodiment of the invention is such that a liquid crystal receiving apparatus 1 automatically adjusts a gain to optimal one for a video signal in accordance with the contents of the video signal concerned.

FIG. 2 is a block diagram showing an internal configuration of the liquid crystal receiving apparatus 1 according to the first embodiment of the invention.

The liquid crystal receiving apparatus 1 includes an IP conversion•Scaler circuit 11, a frame frequency-doubling conversion circuit 12 (image frequency-doubling portion), a timing generating circuit 13 (timing generating circuit portion), a gain controlling circuit 14 (gain adjusting portion), an image adjusting circuit 15 (image adjusting circuit portion), and an LCD panel 16 (image displaying portion). In addition, an antenna 2 is connected from the outside to the liquid crystal receiving apparatus 1.

The IP conversion•Scaler circuit 11 serves as a receiving portion as well, and converts a video signal inputted thereto into another one complying with a progressive system when the inputted video signal complies with an interlace system. In addition, the IP conversion•Scaler circuit 11 converts an image size of the video signal inputted thereto into another one with which a corresponding image can be displayed on the LCD panel 16 when the image size of the inputted video signal is different from another one with which the corresponding image can be displayed on the LCD panel 16.

The frame frequency-doubling conversion circuit 12 doubles a vertical scanning frequency set for the video signal inputted thereto and thus converts the number of frames into doubled one. For example, when the vertical scanning frequency for the inputted video signal is set at 60 Hz, the frame frequency-doubling conversion circuit 12 converts 60 Hz set as the vertical scanning frequency into 120 Hz, and thus converts the number of frames per one second from 60 pieces into 120 pieces.

The timing generating circuit 13 measures timings at which the frames are displayed, respectively, with respect to the frames, of the video signal, the number of which is doubled in the frame frequency-doubling conversion circuit 12, and generates a timing signal with which the gain adjustment is performed.

The gain controlling circuit 14 adjusts a gain for each of the frames in accordance with the timing signal generated by the timing generating circuit 13. In addition, the gain controlling circuit 14 analyzes the received video signal, and sets the gain optimal for the image corresponding to the received video signal.

The image adjusting circuit 15 multiplies each of the frames, corresponding to the video signal, the number of which is doubled by the frame frequency-doubling conversion circuit 12 by a voltage multiplied by the gain adjusted by the gain controlling circuit 14, thereby adjusting an image of each of the frames.

The LCD panel 16 displays thereon the image adjusted by the image adjusting circuit 15. In the invention, a liquid crystal panel is used as the LCD panel 16.

### (Frame Frequency-Doubling Conversion Method and Gain Controlling Method)

Next, a description will now be given with respect to a frame frequency-doubling conversion method and a gain controlling method which are implemented in the liquid crystal receiving apparatus 1 according to the invention. Note that, the following description is given by giving, as an example, the case where the vertical scanning frequency for the received video signal is set at 60 Hz. However, the same processing is executed for a video signal for which the vertical scanning frequency is set at 50 Hz or the like, which results in that the same effects can be obtained.

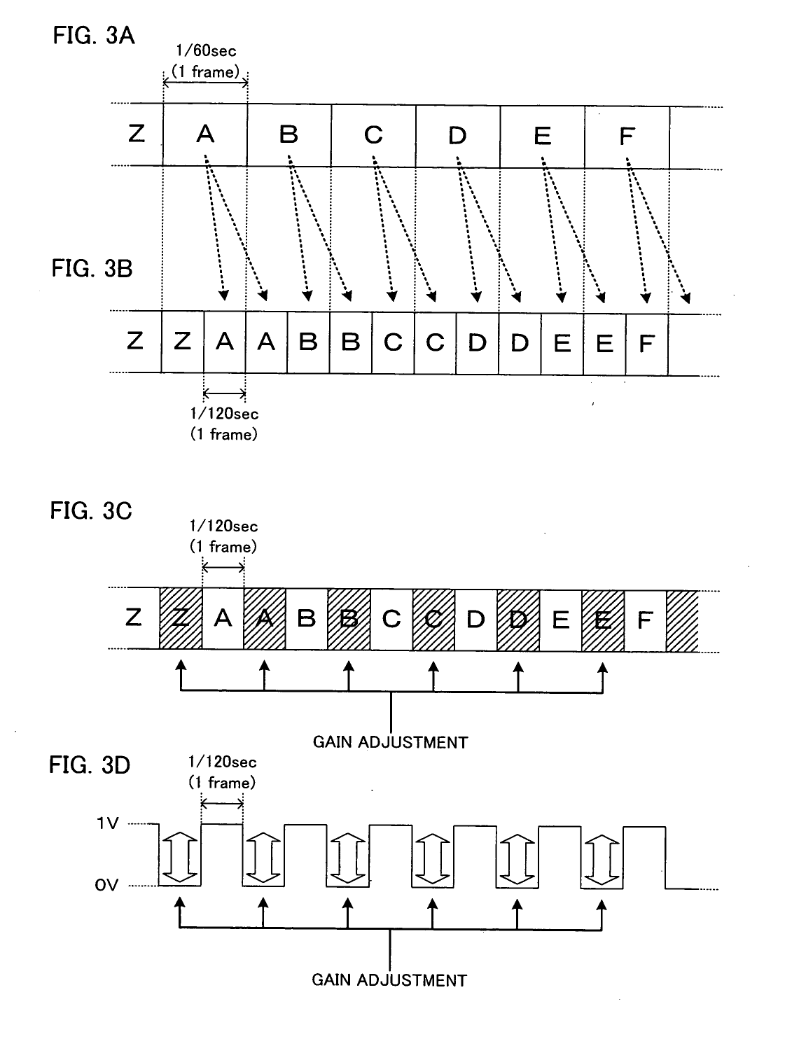

FIGS. 3A to 3D are respectively schematic diagrams showing a situation in which the frame frequency-doubling conversion circuit 12 doubles the number of frames corresponding to the received video signal, and a situation in which the gain for each of ones of the doubled frames is controlled.

FIG. 3A shows the video signal, in a stage of being inputted, before being subjected to the frequency-doubling conversion processing. The liquid crystal receiving apparatus 1 receives one frame every lapse of 1/60 seconds because the vertical scanning frequency of 60 Hz is set for the inputted video signal. As shown in FIG. 3A, the individual frames are designated with reference symbols A, B, C, D, E, F, . . . , respectively, for identification.

Note that, the video signal which is inputted to the frame frequency-doubling conversion circuit 12 through the IP conversion•Scaler circuit 11 is limited to one complying with the progressive system 11 irrespective of the fact relating to whether the received video signal complies with the interlace system or the progressive system.

When such a video signal is inputted to the frame frequency-doubling conversion circuit 12, a time period required to display an image for one frame becomes 1/120 seconds which are half 1/60 seconds before the frame frequency-doubling conversion processing since the vertical scanning frequency set for the video signal is converted from 60 Hz to 120 Hz. Also, since the number of frames is doubled conventional one, the image for one frame of the video signal before the frame frequency-doubling conversion processing is allocated to two frames of the video signal after the frame frequency-doubling conversion processing. FIG. 3B shows this situation.

As shown in FIG. 3B, the image of the frame A in the video signal before the frame frequency-doubling conversion processing is displayed continuously twice with respect to the video signal after the frame frequency-doubling conversion processing. Subsequently, the image of the frame B, and the image of the frame C are displayed in order twice each.

Note that, at this time, since the video signal passes through the frame frequency-doubling conversion circuit 12, the timing at which the image corresponding to the video signal is displayed is slightly delayed as compared with that in the case where the video signal does not pass through the frame frequency-doubling conversion circuit 12. As can be seen from FIGS. 3A and 3B, the display timing is delayed by 1/120 seconds in the video signal shown in FIG. 3B in the case where the video signal passes through the frame frequency-doubling conversion circuit 12 as compared with the video signal shown in FIG. 3A in the case where the video signal does not pass through the frame frequency-doubling conversion circuit 12.

As shown in FIG. 3B, even when the video signal is subjected to the frame frequency-doubling conversion processing, displaying continuously the frame for 1/120 seconds twice is not different from displaying the frame for 1/60 seconds once at all in the liquid crystal display device. Thus, this process does not quite results in that the moving image blur is prevented from occurring. In order to avoid this situation, the gain for the secondly displayed frame of the two frames into which the original frame is displayed continuously twice is adjusted. FIG. 3C shows a video signal for which the gain is adjusted in the manner as described above by the image controlling circuit 14.

FIG. 3C shows that the gain for the secondly displayed frame of the two frames into which the original frame is displayed continuously twice is adjusted and thus the corresponding image becomes slightly dark.

The gain is adjusted in accordance with the timing signal which is generated from the timing generating circuit 13 and the gain controlling circuit 14. FIG. 3D shows an example of the timing signal which is generated in correspondence to the video signal shown in FIG. 3B.

For example, the gain when a voltage of the timing signal is 1 V is set as 100%, and the gain when the voltage of the timing signal is 0 V is set as 0%. Since no gain is adjusted for the firstly displayed frame of the two frames into which the original frame is displayed continuously twice, the gain at this time is set as 100%. Therefore, the voltage of the timing signal corresponding to the firstly displayed frame becomes 1 V.

On the other hand, the timing signal is given a voltage corresponding to the desired gain for the secondly displayed frame of the two frames into which the original frame is displayed continuously twice, which results in that the brightness of the image corresponding to the secondly displayed frame is changed.

The gain, that is, the voltage of the timing signal can be freely adjusted in the range of 0 V (0%) to 1 V (100%). In the first embodiment, the gains having values which are judged to be suitable are set in advance in correspondence to kinds of video signals, respectively, and the setting of the gain corresponding to the kind of inputted video signal is selected. Here, the gain controlling circuit 14 analyzes the video signal, thereby determining the kind of video signal concerned.

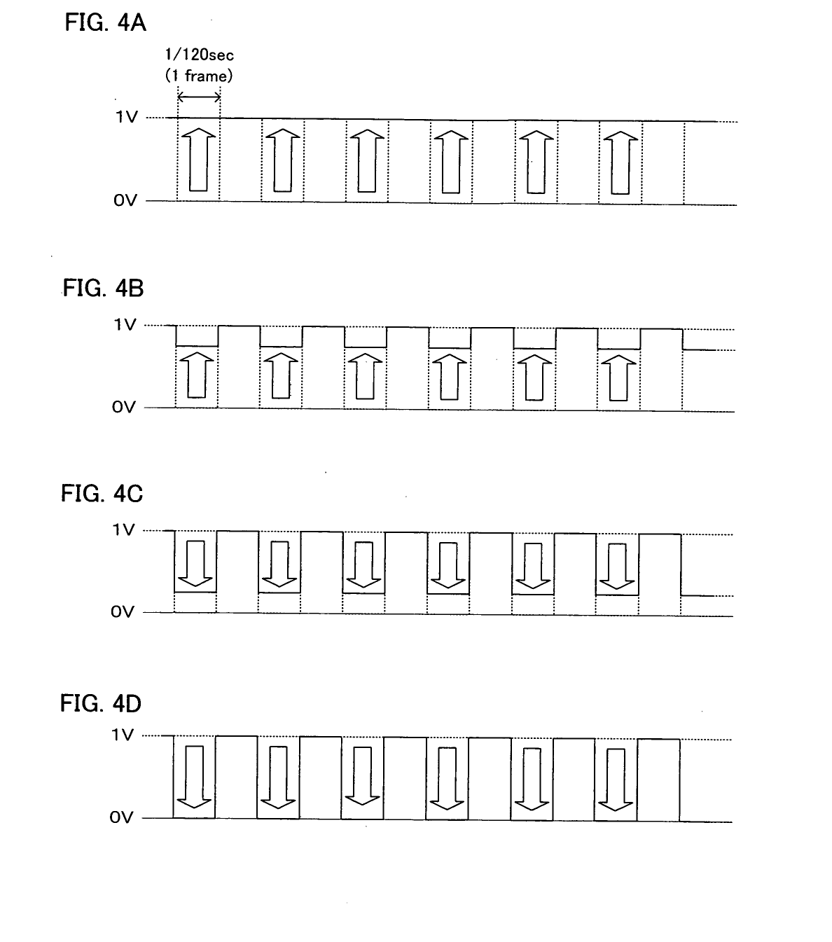

FIGS. 4A to 4D are an example showing a situation in which the gain for the inputted video signal is adjusted in accordance with the value of the gain which is set in advance.

FIG. 4A shows the case where no gain adjustment is performed at all, and the image is displayed with the value of the gain being held at 100%. Since no problem of the moving image blur is caused when an image to be displayed is a still image, such a value of a gain is desirable.

FIG. 4B shows the case where the value of the gain is adjusted to about 75%. When the image displayed on a screen is bright, if the gain is excessively reduced, the flicker becomes easy to stand out. Thus, when there is no need for being nervous too much about a motion in an image, the gain is not reduced too much.

FIG. 4C shows the case where the value of the gain is adjusted to about 25%. In addition, FIG. 4D shows the case where the gain is reduced to 0%. For example, since the picture is essentially dark in an image such as a film, the flicker hardly stands out. Thus, the value of the gain set at 25% or 0% is desirable in this case. In addition, the moving image blur must be suppressed to a minimum in an image as in a sports relay broadcasting or the like. Thus, the value of the gain set at 25% or 0% is desirable in the sports relay broadcasting as well.

Therefore, the gain controlling circuit 14 analyzes the image contents of the inputted video signal, analyzes the speed of a change in image corresponding thereto, and the essential brightness or the like of the image corresponding thereto, and as a result of the analysis, selects the gain which is judged to be most suitable for the image concerned.

It should be noted that the analysis for the image contents of the inputted video signal can also be performed by using an analyzing circuit which is specially provided instead of using the gain controlling circuit 14.

### (Image Adjustment Processing in First Embodiment)

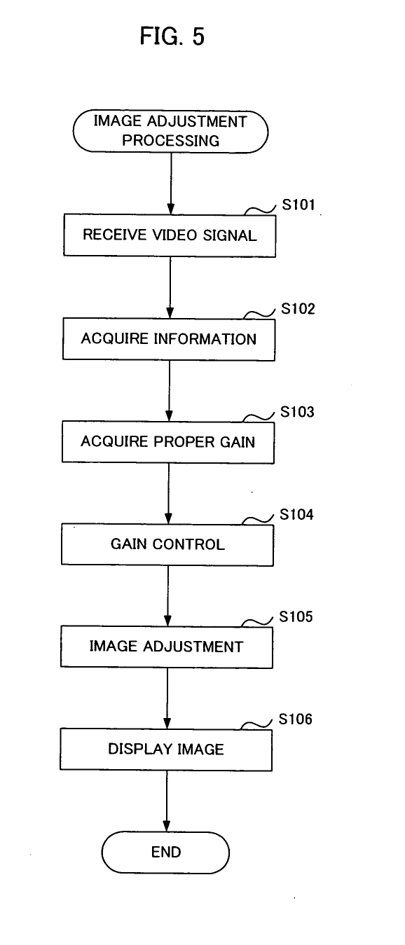

Next, a description will now be given with respect to image adjustment processing executed in the liquid crystal receiving apparatus 1 according to the first embodiment of the invention with reference to a flow chart shown in FIG. 5.

FIG. 5 is a flow chart showing operation when the liquid crystal receiving apparatus 1 receives the video signal and performs the gain adjustment for an image corresponding to the received video signal. Note that, in the flow chart of FIG. 5, a description of any of processing (such as image conversion processing, frame frequency-doubling conversion processing and the like) having no direct relation to the gain adjustment is omitted here for the sake of simplicity.

Firstly, the video signal is received through the antenna 2 (Step S101). Upon reception of the video signal, the gain controlling circuit 14 acquires information relating to a motion, brightness and the like of the image corresponding to the video signal concerned (Step S102).

Next, the optimal gain is acquired among the several gains which are set in advance in corresponding to the image information acquired by the gain controlling circuit 14 (Step S103). Also, the gain controlling circuit 14 adjusts the gain for the timing signal in correspondence to the optimal gain thus acquired (Step S104).

Next, the image adjusting circuit 15 combines the timing signal for which the gain adjustment is performed, and the image for which the frame frequency-doubling conversion is performed with each other, and adjusts each of the images in this state (Step S105). Then, each of the resulting images is displayed on the LCD panel 16 (Step S106).

### (Effects of First Embodiment)

According to the first embodiment of the invention, the gain control circuit 14 analyzes the image, which results in that it is possible to acquire the gain proper for the image, it is possible to display the image for which the gain is automatically adjusted, and it is possible for the user to enjoy the image contents without being nervous about the moving image blur and the flicker.

Note that, although the frame frequency-doubling conversion circuit 12 executes the frequency doubling conversion processing by using the vertical scanning frequency obtained by doubling the vertical scanning frequency set for the received video signal, the frequency-multiplying conversion processing may also be executed by using an arbitrary multiple of the vertical scanning frequency which is set for the received video signal and which is obtained through the process for trebling that vertical scanning frequency or the process for quadrupling that vertical scanning frequency. In this connection, the gain controlling circuit 14 controls the gains for the newly generated frames independently of one another.

### Second Embodiment

### (Configuration of Liquid Crystal Receiving Apparatus)

A liquid crystal receiving apparatus according to a second embodiment of the invention is such that a gain for a video signal is adjusted in accordance with a value selected by a user.

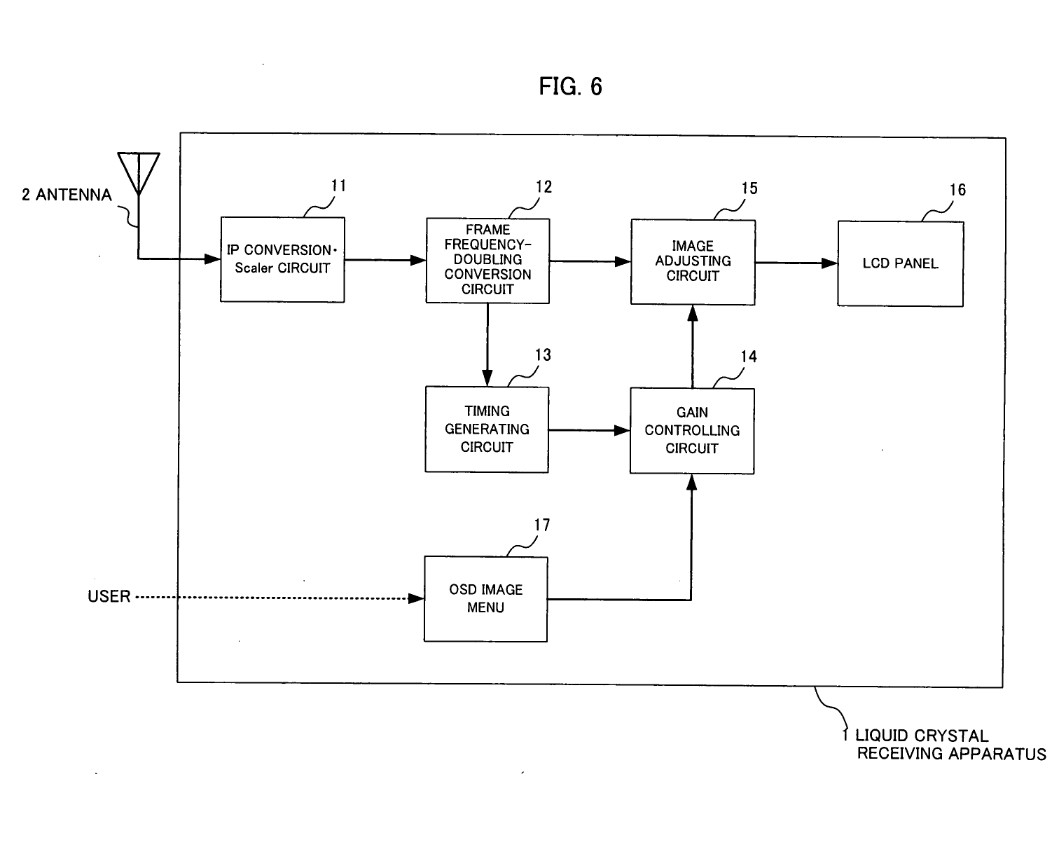

FIG. 6 is a block diagram showing an internal configuration of a liquid crystal receiving apparatus 1 according to the second embodiment of the invention.

The liquid crystal receiving apparatus 1 includes an IP conversion•Scaler circuit 11, a frame frequency-doubling conversion circuit 12, a timing generating circuit 13, a gain controlling circuit 14, an image adjusting circuit 15, an LCD panel 16, and an on screen display (OSD) image menu 17 (image quality-adjusting portion). In addition, an antenna 2 is connected from the outside to the liquid crystal receiving apparatus 1.

The IP conversion•Scaler circuit 11, the frame frequency-doubling conversion circuit 12, the timing generating circuit 13, the gain controlling circuit 14, the image adjusting circuit 15, and the LCD panel 16 are the same as those in the liquid crystal receiving apparatus 1 of the first embodiment described above.

The OSD image menu 17 is a menu with which the user performs a manipulation and performs a setting for the image display with respect to an image displayed on the LCD panel 16 in accordance with the displayed contents on the screen.

### (OSD Image Menu)

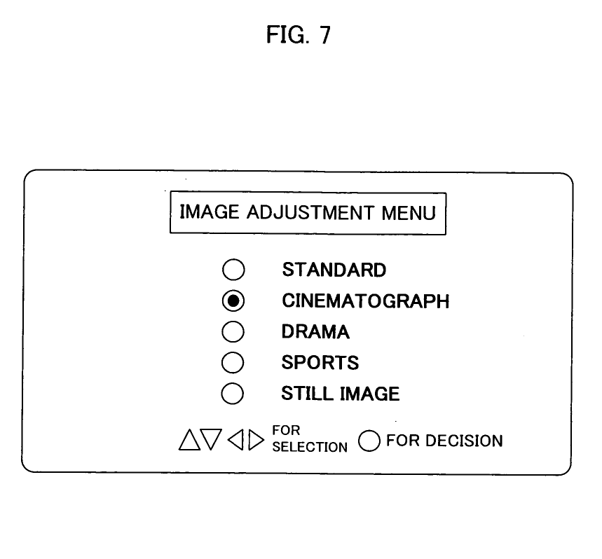

Next, the gain adjustment using the OSD image menu 17 will now be described with reference to FIG. 7.

FIG. 7 is a display example of the gain adjustment menu in the OSD image menu 17 of the liquid crystal receiving apparatus 1 according to the second embodiment of the invention.

The liquid crystal receiving apparatus 1 has a function of adjusting a shade of color of the displayed image. Thus, the user can adjust such a shade of color through a graphic user interface (GUI) displayed on the screen by the OSD image menu 17.

The liquid crystal receiving apparatus 1 according to the second embodiment of the invention can adjust the gain corresponding to the adjustment for the shade of color by transmitting a necessary signal from the OSD image menu 17 to the gain controlling circuit 14 while the shade of color is adjusted by using the OSD image menu 17.

Referring to FIG. 7, for example, five items consisting of “STANDARD”, “CINEMATOGRAPH”, “DRAMA”, “SPORTS”, and “STILL IMAGE” are displayed as the choices. The user selects desired one among these choices by using a remote controller device or the like while referring to these choices.

For example, when “CINEMATOGRAPH” is selected among them, the flicker hardly occurs since a picture of an image of a film is relatively dark. Thus, the gain is adjusted to a lower level.

In addition, when “DRAMA” is selected among them, a motion of an image is not excessively violent although the flicker is easy to occur since the image is brighter than that in the film. Thus, the gain is adjusted to a higher level.

In addition, when “SPORTS” is selected among them, the gain is adjusted to a lower level in order to avoid the moving image blur since the motions of the many images are violent in the case of the sports relay broadcasting.

Also, when “STILL IMAGE” is selected among them, the gain is adjusted to a maximum value because no moving image blur occurs.

### (Image Adjustment Processing in Second Embodiment)

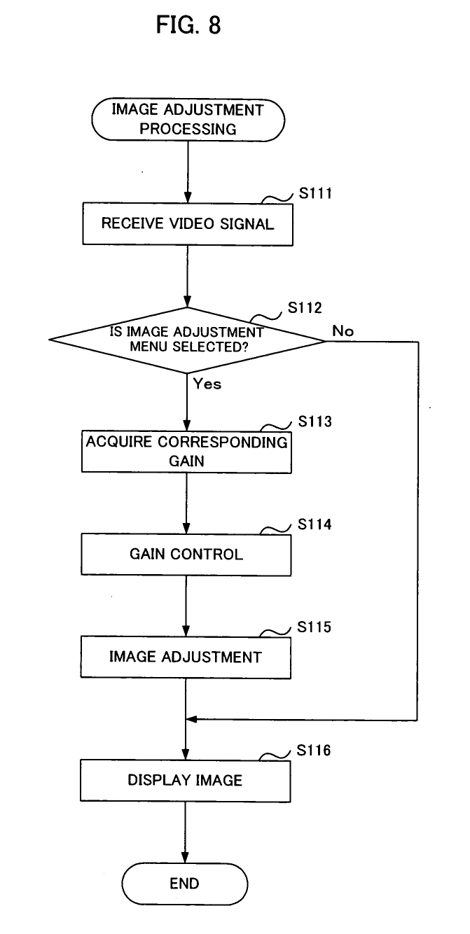

Next, a description will now be given with respect to the image adjustment processing executed in the liquid crystal receiving apparatus 1 according to the second embodiment of the invention with reference to a flow chart shown in FIG. 8.

FIG. 8 is a flow chart showing operation when the liquid crystal receiving apparatus 1 receives a video signal and performs the gain adjustment for an image corresponding to the received video signal in accordance with selection made by the user.

Firstly, a video signal is received through the antenna 2 (Step S111). Upon reception of the video signal, it is judged whether or not the user selects the desired item from the image adjustment menu by using the OSD image menu 17 (Step S112).

When it is judged in Step S112 that the user does not select the desired item from the image adjustment menu (Step S112: No), the processing directly proceeds to Step S116 which will be described later in accordance with the judgment that no gain adjustment is performed. On the other hand, when it is judged in Step S112 that the user selects the desirable item (Step S112: Yes), the gain corresponding to the selected item is acquired among the gains preset in the OSD image menu 17 (Step S113). Also, the gain controlling unit 14 adjusts the gain for the timing signal in accordance with the gain thus acquired (Step S114).

Next, the image adjusting circuit 15 combines the timing signal for which the gain adjustment is performed, and the image for which the frame frequency-doubling conversion processing is executed with each other, and adjusts each of the images in this state (Step S115). Also, each of the resulting images is displayed on the LCD panel 16 (Step S116).

### (Effects of Second Embodiment)

According to the second embodiment of the invention, desired one of the preset gains is acquired from the OSD image menu 17 in accordance with the item selected from the image quality adjustment menu by the user, which results in that it is possible to display the image for which the gain adjustment is optimized for the image quality for each of the items.

Note that, the gain may also be manually adjusted through a manipulation made by the user. For example, the rate of the gain may be adjusted by inputting a numeric value such as “52%”. By adopting such a constitution, it is possible to adjust the optimal gain corresponding to the special feature of each of the images.

It should be noted that the present invention is not limited to the embodiments described above, and the various combinations and changes may be made without departing from or changing the technical idea of the present invention.

What is claimed is:

1. A liquid crystal receiving apparatus, comprising:
a receiving portion for receiving a video signal;
an image frequency-doubling portion for adding frames the number of which increases by doubling a vertical scanning frequency for the video signal to existing frames of the video signal;
a gain adjusting portion for adjusting a gain for each of the frames added in the image frequency-doubling portion; and
an image displaying portion for displaying thereon an image corresponding to a video signal obtained from the existing frames and the added frames for which the gain adjustment is performed.

2. A liquid crystal receiving apparatus according to claim 1, wherein the gain adjusting portion analyzes image contents corresponding to the video signal received by the receiving portion, and performs the gain adjustment in accordance with the analysis results.

3. A liquid crystal receiving apparatus according to claim 2, wherein the gain adjusting portion is adapted to set a range of 0 to 100% of a luminance value of each of the existing frames as a gain adjustment value for each of the added frames.

4. A liquid crystal receiving apparatus according to claim 2, wherein the gain adjusting portion analyzes the image contents corresponding to the video signal received by the receiving portion, and when judging that the image contents relate to a still image, sets a gain adjustment value of each of the added frames as 100% of a luminance value of each of the existing frames.

5. A liquid crystal receiving apparatus according to claim 2, wherein the gain adjusting portion analyzes brightness corresponding to the video signal received by the receiving portion as the image contents, and is adapted to set a range of 0 to 100% of the brightness for each of the existing frames as a gain adjustment value for each of the added frames in accordance with the brightness.

6. A liquid crystal receiving apparatus according to claim 2, wherein the gain adjusting portion analyzes a speed of a change in video signal received by the receiving portion as the image contents, and is adapted to set a range of 0 to 100% of the speed of the change in video signal for each of the existing frames as a gain adjustment value for each of the added frames in accordance with the speed in change in video signal received by the receiving portion.

7. A liquid crystal receiving apparatus according to claim 1, wherein the gain adjusting portion performs the gain adjustment with a value specified by a user.

8. A liquid crystal receiving apparatus according to claim 7, wherein the gain adjusting portion is adapted to set a range of 0 to 100% of a luminance value of each of the existing frames as a gain adjustment value for each of the added frames.

9. A liquid crystal receiving apparatus, comprising:
a receiving portion for receiving a video signal; an image frequency-doubling portion for adding frames the number of which increases by doubling a vertical scanning frequency for the video signal to existing frames of the video signal;
a timing generating circuit portion for generating a timing signal in accordance with the doubled vertical scanning frequency;
a gain adjusting portion for adjusting a gain for the timing signal;
an image adjusting circuit portion for adjusting the gain for each of the added frames by multiplying each of the added frames by the timing signal for which the gain is adjusted, and outputting the resulting added frames together with the existing frames in a form of a video signal; and
an image displaying portion for displaying thereon an image corresponding to the video signal outputted from the image adjusting circuit portion.

10. A liquid crystal receiving apparatus according to claim 9, wherein the gain adjusting portion analyzes image contents corresponding to the video signal received by the receiving portion, and performs the gain adjustment in accordance with the analysis results.

11. A liquid crystal receiving apparatus according to claim 10, wherein the gain adjusting portion is adapted to set a range of 0 to 100% of a luminance value of each of the existing frames as a gain adjustment value for each of the added frames.

12. A liquid crystal receiving apparatus according to claim 10, wherein the gain adjusting portion analyzes the image contents corresponding to the video signal received by the receiving portion, and when judging that the image contents relate to a still image, sets a gain adjustment value of each of the added frames as 100% of a luminance value of each of the existing frames.

13. A liquid crystal receiving apparatus according to claim 10, wherein the gain adjusting portion analyzes brightness corresponding to the video signal received by the receiving portion as the image contents, and is adapted to set a range of 0 to 100% of the brightness for each of the existing frames as a gain adjustment value for each of the added frames in accordance with the brightness.

14. A liquid crystal receiving apparatus according to claim 10, wherein the gain adjusting portion analyzes a speed of a change in video signal received by the receiving portion as the image contents, and is adapted to set a range of 0 to 100% of the speed of the change in video signal for each of the existing frames as a gain adjustment value for each of the added frames in accordance with the speed in change in video signal received by the receiving portion.

15. A liquid crystal receiving apparatus according to claim 9, wherein the gain adjusting portion performs the gain adjustment with a value specified by a user.

16. A liquid crystal receiving apparatus according to claim 15, wherein the gain adjusting portion is adapted to set a range of 0 to 100% of a luminance value of each of the existing frames as a gain adjustment value for each of the added frames.

17. A liquid crystal receiving apparatus, comprising:
a receiving portion for receiving a video signal;
an image frequency-doubling portion for adding frames the number of which increases by doubling a vertical scanning frequency for the video signal to existing frames of the video signal;
an image quality-adjusting portion for performing display adjustment for an image quality;
a gain adjusting portion for adjusting a gain for each of the frames added in the image frequency-doubling portion in accordance with the display adjustment for the image quality made in the image quality-adjusting portion; and
an image displaying portion for displaying thereon an image corresponding to the video signal from which the existing frames, and the added frames for which the gain adjustment is performed are obtained.

18. A liquid crystal receiving apparatus according to claim 17, wherein the image quality-adjusting portion has a plurality of predetermined image quality adjustment modes, and carries out the image quality adjustment mode selected in accordance with specification made by a user.

19. A liquid crystal receiving apparatus according to claim 18, wherein when the image quality adjustment mode relating to a still image is selected in the image quality-adjusting portion, the gain adjusting portion sets 100% of a luminance value of each of the existing frames as a gain adjustment value of each of the added frames.
